(19) United States
(12) Patent Application Publication
(10) Pub. No.: US 2023/0086392 A1
(43) Pub. Date: Mar. 23, 2023

(54) NAVIGATION FOR A ROBOTIC WORK TOOL SYSTEM

(71) Applicant: HUSQVARNA AB, Huskvarna (SE)

(72) Inventor: Jonas Holgersson, Huskvarna (SE)

(21) Appl. No.: 17/892,591

(22) Filed: Aug. 22, 2022

(30) Foreign Application Priority Data
Sep. 23, 2021 (SE) 2151166-2

(51) Int. Cl. B25J 9/16; B25J 11/00

(52) U.S. Cl. CPC B25J 9/1666; B25J 11/0085

(57) ABSTRACT

A robotic work tool arranged to operate in an operational area bounded by a boundary wire, the operational area encompassing a first charging station and a second charging station, each charging station comprising a base station wire, the robotic work tool comprising a controller, wherein the controller is configured to: operate in the operational area according to a first control signal, the first control signal comprising a first boundary signal being transmitted through the boundary wire and a first base station signal being transmitted through the base station wire of the first charging station; navigate the robotic work tool to locate and move the robotic work tool to the first charging station based on the first control signal; navigate the robotic work tool to distance the robotic work tool from the first charging station in a predetermined manner; synchronize to a second control signal comprising a first boundary signal and a second base station signal both being transmitted through the base station wire of the second charging station; and navigate the robotic work tool to enter the second charging station based on the second control signal.

### TECHNICAL FIELD

This application relates to a robotic work tool and in particular to a system and a method for providing an improved navigation for robotic work tools, such as lawnmowers, in such a system.

### BACKGROUND

Automated or robotic work tools such as robotic lawnmowers are becoming increasingly more popular and there is an increasing demand for utilizing more than one robotic work tool in an operational area.

However, there are problems as regards providing charging platforms for multiple robotic work tools in a same operational area.

For example in some solutions for multiple robotic work tools in one operational area, the robotic work tools and their charging stations are using separate control signals (period times) but sharing the same boundary wire where the control signals are being sent. This creates a quite complex disturbance, noise and interference situation for the control signal receiver in the robotic work tools. For example, if three mowers are working in the same operation area, their three charging stations are connected to the same boundary wire. The three charging stations are sending their own A-pulses with different period times. The three A-pulse trains will quite often collide causing missed signals or other more complex problems, causing the robotic work tool software to loose synchronisation with its control signal, or even worse, go outside the boundary wire.

Since typical multi-robotic work tool are installations are large with long distances to the boundary wire, the circumstances for the control receiver in the robotic work tool is already complicated, even without the additional signals from other robotic work tools' charging stations. Also, the electrical interconnection between the charging station electronics causes the transmitted signals from them to be weaker than if only one charging station is connected to the boundary wire.

The charging station connections and/or base platforms create an extra load for each other, on top of the load caused by the length of boundary loop wire.

Thus, there is a need for an improved manner of enabling the operation and charging of multiple robotic work tools in a same operational area.

### SUMMARY

It is therefore an object of the teachings of this application to overcome or at least reduce those problems by providing by providing a robotic work tool arranged to operate in an operational area bounded by a boundary wire, the operational area encompassing a first charging station and a second charging station, each charging station comprising a base station wire, the robotic work tool comprising a controller, wherein the controller is configured to: operate in the operational area according to a first control signal, the first control signal comprising a first boundary signal being transmitted through the boundary wire and a first base station signal being transmitted through the base station wire of the first charging station; navigate the robotic work tool to locate and move the robotic work tool to the first charging station based on the first control signal; navigate the robotic work tool to distance the robotic work tool from the first charging station in a predetermined manner; synchronize to a second control signal comprising a first boundary signal and a second base station signal both being transmitted through the base station wire of the second charging station; and navigate the robotic work tool to enter the second charging station based on the second control signal.

In some embodiments the robotic work tool is associated with the second charging station, and wherein the controller is further configured to determine that the robotic work tool is associated with the second charging station based on settings.

In some embodiments the robotic work tool further comprises a sensor (185) for deduced reckoning, and wherein the controller is further configured to navigate the robotic work tool to distance the robotic work tool from the first charging station in the predetermined manner based on deduced reckoning.

In some embodiments the controller is further configured to navigate the robotic work tool to distance the robotic work tool from the first charging station in the predetermined manner based on the first control signal.

In some embodiments the controller is further configured to determine that the robotic work tool is unable to synchronize to the second control signal, and in response thereto navigate the robotic work tool to reposition the robotic work tool and reattempt to synchronize to the second control signal.

In some embodiments the controller is further configured to reposition the robotic work tool by navigating the robotic work tool to the first charging station based on the first control signal.

In some embodiments the controller is further configured to reposition the robotic work tool by navigating the robotic work tool to move a distance.

In some embodiments the controller is further configured to reposition the robotic work tool by navigating the robotic work tool in a random pattern searching for the second control signal.

In some embodiments the controller is further configured to navigate the robotic work tool to distance the robotic work tool from the first charging station in the predetermined manner by moving the robotic work tool a predetermined distance from the first charging station.

In some embodiments the predetermined distance is based on a range of the base station field (R).

In some embodiments the predetermined distance is 2, 3, or 5 meters or in the range 1-5, 2-6, 3-7 or 2-10 meters.

In some embodiments the controller is further configured to navigate the robotic work tool to distance the robotic work tool from the first charging station in the predetermined manner by turning and then moving the robotic work tool a predetermined distance in a straight line from the first charging station.

In some embodiments the controller is further configured to navigate the robotic work tool to distance the robotic work tool from the first charging station in the predetermined manner by moving the robotic work tool in a random or semi-random manner.

It is also an object of the teachings of this application to overcome the problems by providing a method for use in a robotic work tool arranged to operate in an operational area bounded by a boundary wire, the operational area encompassing a first charging station and a second charging station, each charging station comprising a base station wire, the method comprising: operating in the operational area according to a first control signal, the first control signal comprising a first boundary signal being transmitted through the boundary wire and a first base station signal being transmitted through the base station wire of the first charging station; navigating the robotic work tool to locate and move the robotic work tool to the first charging station based on the first control signal; navigating the robotic work tool to distance the robotic work tool from the first charging station in a predetermined manner; synchronizing to a second control signal comprising a first boundary signal and a second base station signal both being transmitted through the base station wire of the second charging station; and navigating the robotic work tool to enter the second charging station based on the second control signal.

It is also an object of the teachings of this application to overcome the problems by providing a robotic work tool system comprising a first robotic work tool associated with a first charging station and one or more second robotic work tools each associated with a second charging station, wherein at least one of the one or more second robotic work tools is a robotic work tool according to herein.

It is also an object of the teachings of this application to overcome the problems by providing a charging station arranged to be used with a robotic work tool, wherein the charging station comprises a signal generator arranged to generate a boundary control signal and a base station signal and wherein the charging station is arranged to transmit both the boundary control signal and the base station signal through a base station wire.

In some embodiments the charging station comprises the base station wire and a base plate, wherein the base station wire is arranged in the base plate.

In some embodiments the charging station is arranged to be connected to a boundary wire, and is arranged to not transmit the boundary control signal through the boundary wire, when transmitting the boundary control signal through the base station wire.

In some embodiments the charging station is arranged to be used together with a robotic work tool according to herein.

In some embodiments the robotic work tool is a robotic lawnmower.

Further embodiments and aspects are as in the attached patent claims and as discussed in the detailed description.

Other features and advantages of the disclosed embodiments will appear from the following detailed disclosure, from the attached dependent claims as well as from the drawings. Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention will be described in further detail under reference to the accompanying drawings in which:

FIG. 1A shows an example of a robotic lawnmower according to some embodiments of the teachings herein;

FIG. 1B shows a schematic view of the components of an example of a robotic work tool being a robotic lawnmower according to some example embodiments of the teachings herein;

FIG. 2A shows a schematic view of a robotic work tool system according to some example embodiments of the teachings herein;

FIG. 2B shows a schematic view of a robotic work tool system according to some example embodiments of the teachings herein;

FIG. 2C shows a schematic view of a robotic work tool system according to some example embodiments of the teachings herein;

FIG. 2D shows a schematic view of a robotic work tool system according to some example embodiments of the teachings herein;

FIG. 2E shows a schematic view of a robotic work tool system according to some example embodiments of the teachings herein;

FIG. 2F shows a schematic view of a robotic work tool system according to some example embodiments of the teachings herein; and

FIG. 3 shows a corresponding flowchart for a method according to some example embodiments of the teachings herein.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein. Like reference numbers refer to like elements throughout.

It should be noted that even though the description given herein will be focused on robotic lawnmowers, the teachings herein may also be applied to, robotic ball collectors, robotic watering, robotic farming equipment, or other robotic work tools.

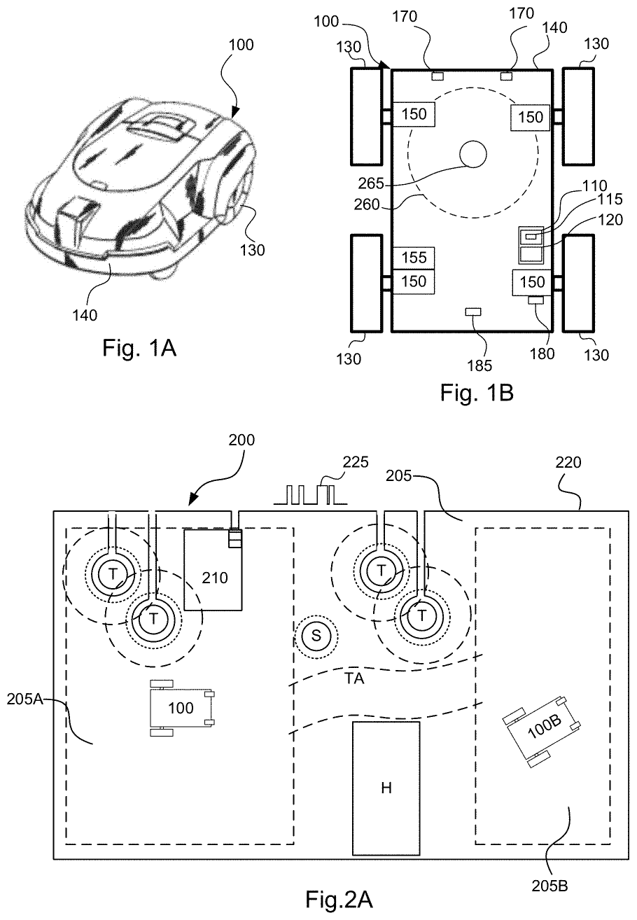

FIG. 1A shows a perspective view of a robotic work tool 100, here exemplified by a robotic lawnmower 100, having a body 140 and a plurality of wheels 130 (only one side is shown). The robotic work tool 100 may be a multi-chassis type or a mono-chassis type (as in FIG. 1A). A multi-chassis type comprises more than one main body parts that are movable with respect to one another. A mono-chassis type comprises only one main body part.

It should be noted that robotic lawnmower may be of different sizes, where the size ranges from merely a few decimetres for small garden robots, to even more than 1 meter for large robots arranged to service for example airfields.

It should be noted that even though the description herein is focussed on the example of a robotic lawnmower, the teachings may equally be applied to other types of robotic work tools, such as robotic watering tools, robotic golfball collectors, and robotic mulchers to mention a few examples.

It should also be noted that the robotic work tool is a self-propelled robotic work tool, capable of autonomous navigation within a work area, where the robotic work tool propels itself across or around the work area in a pattern (random or predetermined).

FIG. 1B shows a schematic overview of the robotic work tool 100, also exemplified here by a robotic lawnmower 100. In this example embodiment the robotic lawnmower 100 is of a mono-chassis type, having a main body part 140. The main body part 140 substantially houses all components of the robotic lawnmower 100. The robotic lawnmower 100 has a plurality of wheels 130. In the exemplary embodiment of FIG. 1B the robotic lawnmower 100 has four wheels 130, two front wheels and two rear wheels. At least some of the wheels 130 are drivably connected to at least one electric motor 150. It should be noted that even if the description herein is focused on electric motors, combustion engines may alternatively be used, possibly in combination with an electric motor. In the example of FIG. 1B, each of the wheels 130 is connected to a common or to a respective electric motor 155 for driving the wheels 130 to navigate the robotic lawnmower 100 in different manners. The wheels, the motor 155 and possibly the battery 150 are thus examples of components making up a propulsion device. By controlling the motors 150, the propulsion device may be controlled to propel the robotic lawnmower 100 in a desired manner, and the propulsion device will therefore be seen as synonymous with the motor(s) 150.

It should be noted that wheels 130 driven by electric motors is only one example of a propulsion system and other variants are possible such as caterpillar tracks.

The robotic lawnmower 100 also comprises a controller 110 and a computer readable storage medium or memory 120. The controller 110 may be implemented using instructions that enable hardware functionality, for example, by using executable computer program instructions in a general-purpose or special-purpose processor that may be stored on the memory 120 to be executed by such a processor. The controller 110 is configured to read instructions from the memory 120 and execute these instructions to control the operation of the robotic lawnmower 100 including, but not being limited to, the propulsion and navigation of the robotic lawnmower.

The controller 110 in combination with the electric motor 155 and the wheels 130 forms the base of a navigation system (possibly comprising further components) for the robotic lawnmower, enabling it to be self-propelled as discussed under FIG. 1A,

The controller 110 may be implemented using any suitable, available processor or Programmable Logic Circuit (PLC). The memory 120 may be implemented using any commonly known technology for computer-readable memories such as ROM, FLASH, DDR, or some other memory technology.

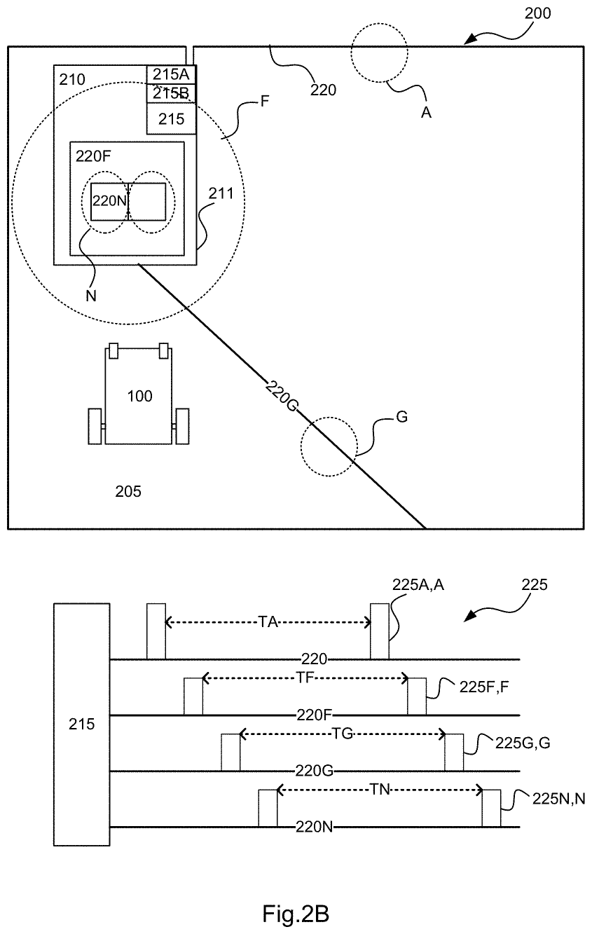

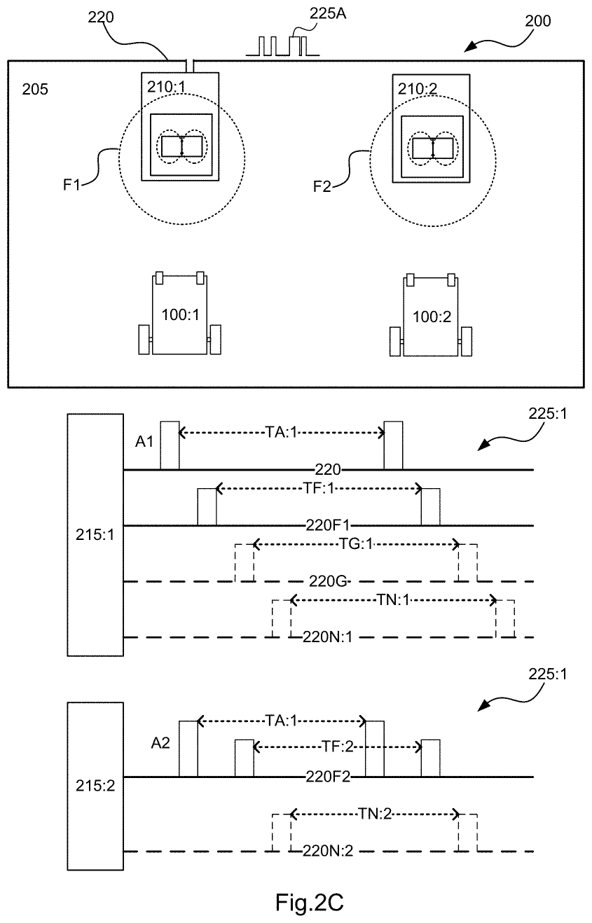

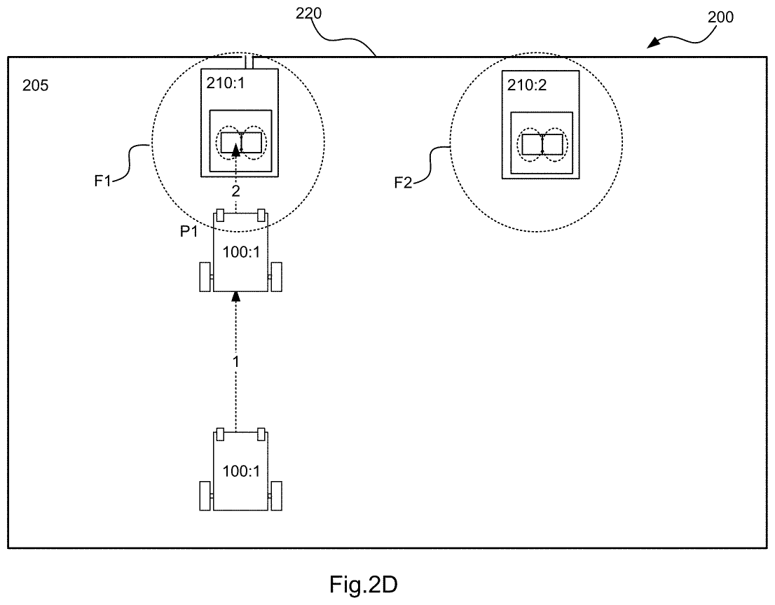

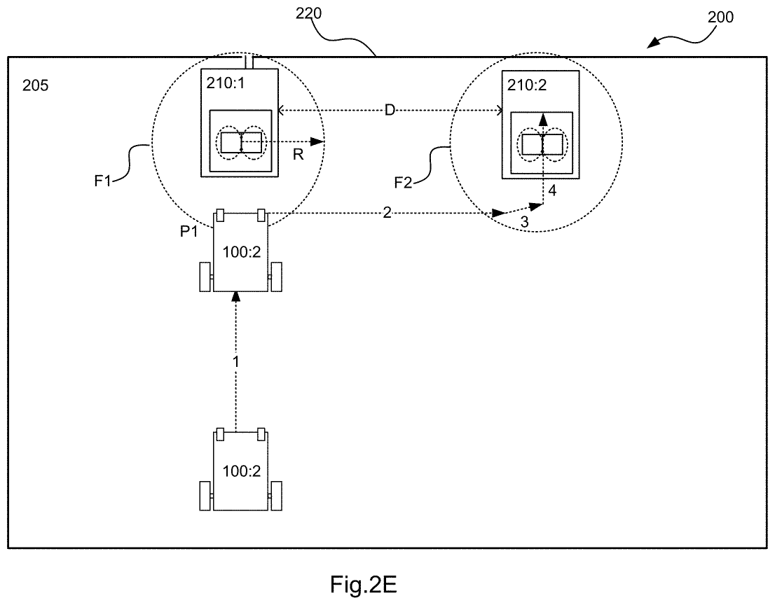

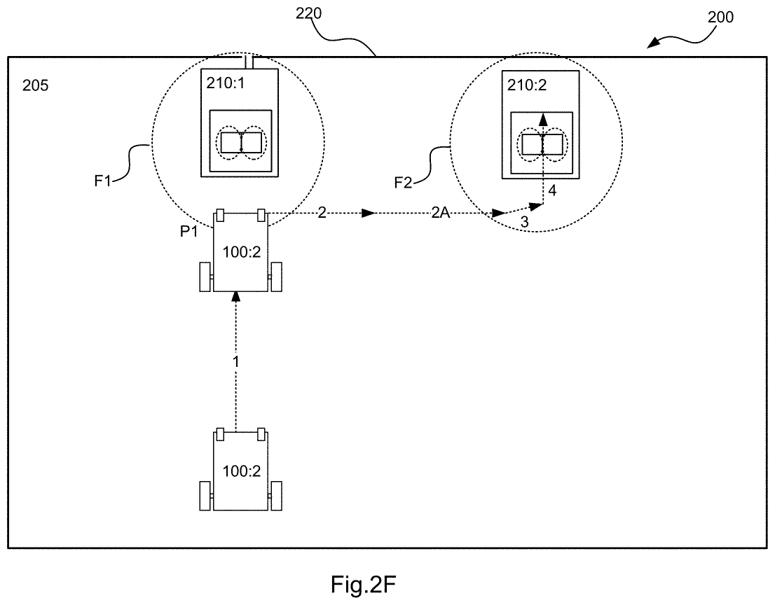

The robotic lawnmower 100 is further arranged with a wireless communication interface 115 for communicating with other devices, such as a server, a personal computer, a smartphone, the charging station, and/or other robotic work tools. Examples of such wireless communication devices are Bluetooth®, WiFi® (IEEE802.11b), Global System Mobile (GSM) and LTE (Long Term Evolution), to name a few. The robotic lawnmower 100 may be arranged to communicate with a user equipment 200 as discussed in relation to FIG. 2 below for providing information regarding status, location, and progress of operation to the user equipment 200 as well as receiving commands or settings from the user equipment 200. Alternatively or additionally, the robotic lawnmower 100 may be arranged to communicate with a server (referenced 240 in FIG. 2A) for providing information regarding status, location, and progress of operation as well as receiving commands or settings.

The robotic lawnmower 100 also comprises a grass cutting device 160, such as a rotating blade 160 driven by a cutter motor 165. The grass cutting device being an example of a work tool 160 for a robotic work tool 100.

For enabling the robotic lawnmower 100 to navigate with reference to a wire, such as a boundary wire, emitting a magnetic field caused by a control signal transmitted through the wire, the robotic lawnmower 100 is further configured to have at least one magnetic field sensor 170 arranged to detect the magnetic field and for detecting the wire (and/or for receiving and possibly also sending information to/from a signal generator). In some embodiments, the sensors 170 may be connected to the controller 110, possibly via filters and an amplifier, and the controller 110 may be configured to process and evaluate any signals received from the sensors 170. The sensor signals are caused by the magnetic field being generated by the control signal being transmitted through the wire. This enables the controller 110 to determine whether the robotic lawnmower 100 is close to or crossing the wire. This also enables the controller 110 to determine if the robotic work tool 100 is inside or outside an area enclosed by the wire. Furthermore, by utilizing two or more sensors 170, the robotic work tool is enabled to follow the wire, both over it and at a distance to it. This will be discussed in further details with reference to FIG. 2B.

The robotic lawnmower 100 may also or alternatively comprise deduced reckoning sensors 180. The deduced reckoning sensors may be odometers, accelerometer or other deduced reckoning sensors. In some embodiments, the deduced reckoning sensors are comprised in the propulsion device, wherein a deduced reckoning navigation may be provided by knowing the current supplied to a motor and the time the current is supplied, which will give an indication of the speed and thereby distance for the corresponding wheel.

The robotic lawnmower 100 may further comprise at least one navigation sensor, such as a beacon navigation sensor and/or a satellite navigation sensor 185. The beacon navigation sensor may be a Radio Frequency receiver, such as an Ultra Wide Band (UWB) receiver or sensor, configured to receive signals from a Radio Frequency beacon, such as a UWB beacon. The satellite navigation sensor may be a GPS (Global Positioning System) device (or other Global Navigation Satellite System (GNSS) device) or a RTK device.

As mentioned above, in some embodiments, the robotic lawnmower 100 is in some embodiments arranged to operate according to a map application representing one or more work areas (and possibly the surroundings of the work area(s)) stored in the memory 120 of the robotic lawnmower 100. The map application may be generated or supplemented as the robotic lawnmower 100 operates or otherwise moves around in the operational area 205. In some embodiments, the map application includes one or more start regions and one or more goal regions for each work area. In some embodiments, the map application also includes one or more transport areas.

FIG. 2A shows a robotic work tool system 200 in some embodiments. The schematic view is not to scale. The robotic work tool system 200 comprises two or more robotic work tools 100 according to the teachings herein. It should be noted that the operational area 205 shown in FIG. 2A is simplified for illustrative purposes. The robotic work tool system comprises a boundary 220 that may be virtual and/or electro mechanical such as a magnetic field generated by a control signal 225 being transmitted through a boundary wire, and which magnetic field is sensed by sensor in the robotic work tool 100.

The robotic work tool system 200 further comprises two or more charging stations 210. The robotic work tool system may comprise a charging station by the charging station being connected directly to the system, or indirectly by the charging statin being placed in the operational area and cooperating with any, some or all of the components of the robotic work tool system 200, specifically one or more of the robotic work tools100.

In some embodiments, each charging station 210 comprises a signal generator 215 configured to generate one or more control signals 225 to be transmitted through one or more wire, such as a boundary wire 220, a guide wire, a station guiding field wire (so-called F-field) and/or a docking field wire (so-called N-field). More details on the use of the signal generator, the control signal(s) and the various wires will be discussed in relation to FIG. 2B.

As with FIGS. 1A and 1B, the robotic work tool(s) is exemplified by a robotic lawnmower, whereby the robotic work tool system may be a robotic lawnmower system or a system comprising a combinations of robotic work tools, one being a robotic lawnmower, but the teachings herein may also be applied to other robotic work tools adapted to operate within a work area.

The one or more robotic working tools 100 of the robotic work tool system 200 are arranged to operate in an operational area 205, which in this example comprises a first work area 205A and a second work area 205B connected by a transport area TA. However, it should be noted that an operational area may comprise a single work area or one or more work areas, possibly arranged adjacent for easy transition between the work areas, or connected by one or more transport paths or areas, also referred to as corridors. In the following work areas and operational areas will be referred to interchangeably, unless specifically indicated.

The operational area 205 is in this application exemplified as a garden, but can also be other operational areas as would be understood, such as an airfield. As discussed above, the garden may contain a number of obstacles, for example a number of trees, stones, slopes and houses or other structures.

In some embodiments the robotic work tool is arranged or configured to traverse and operate in operational areas or work areas that are not essentially flat, but contain terrain that is of varying altitude, such as undulating, comprising hills or slopes or such. The ground of such terrain is not flat and it is not straightforward how to determine an angle between a sensor mounted on the robotic work tool and the ground. The robotic work tool is also or alternatively arranged or configured to traverse and operate in a work area that contains obstacles that are not easily discerned from the ground. Examples of such are grass or moss covered rocks, roots or other obstacles that are close to ground and of a similar colour or texture as the ground. The robotic work tool is also or alternatively arranged or configured to traverse and operate in a work area that contains obstacles that are overhanging, i.e. obstacles that may not be detectable from the ground up, such as low hanging branches of trees or bushes. Such a garden is thus not simply a flat lawn to be mowed or similar, but a work area of unpredictable structure and characteristics. The operational area 205 exemplified with referenced to FIG. 2A, may thus be such a non-uniform work area as disclosed in this paragraph that the robotic work tool is arranged to traverse and/or operate in.

As shown in FIG. 2A, the robotic working tools 100 and 100B are arranged to navigate in one or more work areas 205A, 205B, possibly connected by a transport area TA. It should be noted that even if the two robotic work tools 100, 100B are shown as working in separate work areas 205A, 205B, this is only one example, and as a skilled person would understand, the two robotic work tools 100, 100B may equally well be working in a same work area, being the general work area of the operational are 205 or either of the two (or more) work areas 205A, 205B.

In the below several embodiments of how the robotic work tool may be adapted will be disclosed. It should be noted that all embodiments may be combined in any combination providing a combined adaptation of the robotic work tool.

FIG. 2B shows a simplified, schematic view of the robotic work tool system 200 as disclosed in relation to FIG. 2A. In FIG. 2B COMPONENTS OF THE SIGNAL GENERATOR 215 OF THE CHARGING STATION 210 IS SHOWN. The signal generator comprises a memory 215B for storing instructions for the overall control of the signal generator and for signal forms to be used and a controller 215A configured to generate a control signal according to the instructions. The signal generator also comprises an amplifier, assumed to be part of the controller for the purpose of the teachings herein. The signal generator is thus configured to generate and transmit a control signal 225. As will be discussed in the below a control signal can be seen as comprising a plurality of partial control signals or be a composite of several signals being transmitted through the same or through different wires, each (partial) control signal generating a corresponding magnetic field around the wire the signal is being transmitted through. The magnetic fields are indicated as dotted lines in FIG. 2B

The signal generator 215 of FIG. 2B is connected to a boundary wire 220 for transmitting a boundary signal A for keeping the robotic work tool inside the operational area and a so-called F-field wire 220F transmitting a so-called F-signal F for enabling the robotic work tool to find the charging station 210. The F-signal and the F-wire will hereafter also be referred o as a base station signal and a base station wire respectively. As is indicated in FIG. 2B, the F-wire 220F is arranged in a base plate 211 of the charging station 210, thus forming a small loop. The F-wire 225F is arranged fully within the charging station 210 and mostly within the base plate 211 and does not extend beyond or outside the charging station. In some embodiments the F-wire 225F is arranged primarily (mostly) in the base plate 211, except for connections to the signal generator, The resulting magnetic field, the F-field is comparatively strong inside the loop, but the signal strength falls of rather rapidly outside the loop, resulting in a radius of the F-field of a few meters, for example 2, 3, or 5 meters.

In some embodiments, the signal generator 215 is also connected to a docking wire 220N for transmitting a signal generating a magnetic field N for enabling the robotic work tool to be guided during the docking in the charging station. As is known in the field, other alternatives exist for facilitating docking in the charging station, such as use of guide wires, or the boundary wire running through the charging station.

Optionally, in some embodiments, the signal generator 215 is also connected to a guide wire 220G for transmitting a guide signal generating a magnetic guide field G for enabling the robotic work tool to be guided to a specific position in the operational area.

The lower half of FIG. 2B shows how the signal generator 215 is configured to transmit one control signal through each of the wires. In this example, the control signal(s) is a pulsed signal where a pulse train (possibly a single pulse) is transmitted at a period T through each corresponding wire. In the example of FIG. 2B all signals have the same period (TA=TF=TG=TN).

It should be noted that the exact type of control signals being used may be different in different embodiments and that many alternatives exist [EXAMPLES].

To be noted is that one (partial) control signal is transmitted through the boundary wire 220 and one (partial) control signal is transmitted through the F-wire 220F.

Such signal generator arrangements are commonly known in the field and will not be discussed in further detail herein, except as pertains to the invention.

FIG. 2C shows a simplified view of a robotic work tool system 200 as in FIG. 2A and FIG. 2B. FIG. 2C shows the robotic work tool system 200 comprising two robotic work tools 100:1, 100:2 each associated with a respective charging station 210:1, 210:2. Each charging station 210:1, 210:2 comprises a respective signal generator 215:1, 215:2. Each signal generator 215:1, 215:2 is configured to generate an F field Fl, F2 respectively.

Notably the first signal generator 215:1 is also connected to the boundary wire 220 for generating and transmitting a boundary control signal 225A, whereas the second signal generator 215:2 need not be connected to the boundary wire. The second signal generator 215:2 is however also configured to generate and transmit a boundary control signal, but not through the boundary wire 220.

As indicated in the lower half of FIG. 2C, the first signal generator 215:1 generates and transmit various signals through various wires, as discussed in regards to FIG. 2B. However, the and second signal generator 215:2 generates and transmits a boundary control signal A and an F-field signal F through the same wire, namely the F-wire 220F:2 connected to the second signal generator 215:2.

In some embodiments, the second signal generator also generates and transmits an N-signal through the N-wire 220N for facilitating docking.

As is also shown in FIG. 2C the first and second control signals A:1 and A:2 are different as is indicated by the difference in (time) periods for the two signals (TA:1=1=TA:2). The two control signals can thus be differentiated from one another.

The first robotic work tool 100:1 is configured to operate during operation in the operational area 205 according to the control signal 225:1 of the first signal generator 215:1.

Contrary to prior art systems having different signal generators generating and transmitting different control signals, the second robotic work tool 100:2 is also configured to operate during operation in the operational area 205 according to the control signal 225:1 of the first signal generator 215:1.

During operation both the first robotic work tool 100:1 and the second robotic work tool 100:2 thus operate according to the control signal 225:1 of the first signal generator 215:1.

FIG. 2D shows a simplified view of a robotic work tool system 200 as in FIG. 2A, FIG. 2B and FIG. 2C. FIG. 2D shows a charging procedure for the first robotic work tool 100:1. The first robotic work tool 100:1 locates the first charging station 210:1. There exist many possibilities of how to locate the charging station, and the description herein will focus on what happens as the robotic work tool 100 has located the first charging station 210.

As the charging station has been located, the robotic work tool 100:1 moves to a first position P1 close to the charging station, such as in front of the charging station. This is indicated by the arrow marked “1” in FIG. 2D. In some embodiments the first point is a point where docking is to be commenced, i.e. a docking point. In embodiments utilizing both an N-field and an F-field, such a point is well-defined, as is known.

As the robotic work tool 100:1 is associated with the first charging station, the first robotic work tool 100:1 simply proceeds and docks in the charging station (as indicted by the dotted arrow marked 2) using any known manner of docking, such as by navigating based on the N-field. The robotic work tool 100:1, is in some embodiments configured to determine that it is associated with the first charging station by being programmed to this. In some embodiments the first robotic work tool 100:1 configured to determine that it is associated with the first charging station through settings, wherein a robotic work tool may be indicated to be the first robotic work tool through the settings, during an initialization.

In some embodiments the first robotic work tool 100:1 configured to determine that it is associated with the first charging station through settings received from a server, wherein a robotic work tool may be indicated to be the first robotic work tool through the settings, during an initialization or during a startup.

FIG. 2E shows a simplified view of a robotic work tool system 200 as in FIG. 2A, FIG. 2B, FIG. 2C and FIG. 2D. FIG. 2E shows a charging procedure for the second robotic work tool 100:2. The second robotic work tool 100:2 locates the first charging station 210:1 in much the same manner as the first robotic work tool 100:1 as discussed in relation to FIG. 2D, and the second robotic work tool also moves to the first position P, as indicted by the dotted arrow marked 1. Here the second robotic work tool determines that it is not associated with the first charging station 215:1.This may be done in a manner similar to how the first robotic work tool determines that it is associated with the first charging station, i.e. through settings for example. The determination may be explicit or implicit and automatic in the robotic work tool's internal instructions.

In any case, the second robotic work tool is configured to distance itself from the first charging station in a predetermined manner, as indicated by the dotted arrow marked 2.

In some embodiments, the second robotic work tool is configured to distance itself, by moving a predetermined distance, indicated D. The second robotic work tool is in some such embodiments configured to do this by turning 90 degrees in a predetermined direction and propel itself the predetermined distance D. In some such embodiments, the predetermined distance D corresponds to the range of the F-filed and is at least twice the range (indicated R in FIG. 2E). In some such alternative or additional embodiments, the predetermined distance D is 2, 3, or 5 meters. In some such embodiments, the predetermined distance D is in the range 1-5, 2-6, 3-7 or 2-10 meters.

As the second robotic work tool 100:2 has distanced itself, the second robotic work tool attempts to synchronize to the second control signal 225:2. The manner of synchronizing to the control signal depends on the type of control signal being used. In the example of a pulsed signal with a specific time period, the second robotic work tool will start searching for the control signal using or based on the associated time period.

As the second robotic work tool 100:2 synchronizes to the second control signal 225:2, the second robotic work tool 100:2 navigates in the second F-filed F2 as indicated by the dotted arrow marked 3 to be able to dock in the second charging station 210:2 as indicated by the dotted arrow marked 4. There are many alternative as how to navigate based on the F-field and how to dock in the charging station as a skilled person would realize. A key point here is that both the second boundary signal and the second F-signal are transmitted through the F-guide wire 220F:2.

As the second control signal is transmitted through the F-wire it has a limited range, and will thus not cause the signal environment in the operational area 205 to become cluttered with signals, i.e. it will not add (significantly, noticeable or at all) to the interference and noise in the operational area 205.

In some embodiments the second robotic work tool 100:2 stops operating according to the first control signal 225:1 while distancing itself. In such embodiments, the navigation during the distancing may be made utilizing deduced reckoning.

In some embodiments the second robotic work tool 100:2 continues operating according to the first control signal 225:1 while distancing itself. In such embodiments, the navigation during the distancing may be made based on the first control signal, possibly in combination with utilizing deduced reckoning. Deduced reckoning may involve navigating according to odometry, accelerometers or any combination of such measures or other known deduced reckoning measures. As an alternative or a supplement, the navigation may be based on satellite navigation or beacon navigation. In such embodiments, the predetermined manner is thus to navigate using deduced reckoning and/or satellite- (or beacon-) based navigation to distance the robotic work tool, possibly by fooling the boundary wire 220.

As an alternative or a supplement, the navigation may be based on following the boundary wire 220, thereby still being synchronized to the first control signal 225:1, as in following the boundary wire 220 based on the first boundary signal 225A, A.

FIG. 2F shows a simplified view of a robotic work tool system 200 as in FIG. 2A, FIG. 2B, FIG. 2C, FIG. 2D and FIG. 2E. FIG. 2F shows a situation where the second robotic work tool 100:2 is not able to synchronize with the second control signal 225:2. In some embodiments, the second robotic work tool is then configured to operate according to the first control signal 225:1 (possibly after resynchronizing to the first control signal 225:1) to reposition itself for a second or further attempt at synchronizing with the second control signal 225:2.

In some embodiments, as shown in in FIG. 2F, the robotic work tool is configured to reposition itself by distancing itself a further distance, as indicated by the dotted arrow marked 2A. In some such embodiments, the further distance is half the predetermined distance D.

It should be noted that any, some or all of the components of the second control signal 225:2 may be the same as the corresponding component(s) of the first control signal.

In some embodiments, as shown in in FIG. 2F, the robotic work tool is configured to reposition itself by returning to the first charging station and repeat the attempt at finding the second charging station. In some such embodiments the robotic work tool is further configured to continue operating for a short time period (1, 2, 3, 4 or 5 minutes) and then repeat the attempt to find the second charging station, starting by finding the first charging station again.

In some embodiments, as shown in in FIG. 2F, the robotic work tool is configured to reposition itself by moving in a more or less random pattern inside a small ara (spanning, 1, 2, or 3) meters. This is similar to how prior art robotic work tools move in order to regain synchronization with a lost control signal. In such an embodiment, the attempt to synchronize may be continues with the repositioning.

As it may take some time to synchronize with the second control signal, and to avoid that the robotic work tool exits the operational area (especially in embodiments where the robotic work tool is not able to simultaneously be synchronized to the first control signal), the robotic work tool is configured to halt or at least slow down when attempting to synchronize.

It should be noted that even though the description herein separates between a first and a second robotic work tool, they may be of the same type and configured for the same operation, possibly based on settings.

It should be noted that even though the description herein is centered around examples of a first and a second robotic work tool, the robotic work tool system may comprise more than one second robotic work tool, each associated with its own charging station.

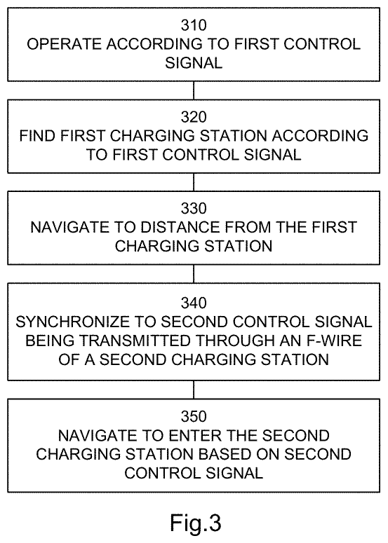

FIG. 3 shows a flowchart for a general method according to herein. The method is for use in a robotic work tool as in FIGS. 1A and 1B. The robotic work tool is configured for operating 310 in the operational area 205 according to a first control signal 225:1, the first control signal comprising a first boundary signal 225:1 being transmitted through the boundary wire 220 and a first base station signal F1 being transmitted through the base station wire 220F:1 of the first charging station 210:1. The method further comprises navigating 320 the robotic work tool 100 to locate and move the robotic work tool 100 to the first charging station 210:1 based on the first control signal 225:1. Then the robotic work tool navigates 330 to distance the robotic work tool from the first charging station 210:1 in a predetermined manner and then synchronizes 340 to a second control signal 225:2 comprising a first boundary signal and a second base station signal F2 both being transmitted through the base station wire 220F:2 of the second charging station 210:2. Then, the robotic work tool 100 navigates to enter the second charging station based on the second control signal 225:2.

A robotic work tool may thus in some embodiments be configured to perform the method according to FIG. 3.

1. A robotic work tool arranged to operate in an operational area bounded by a boundary wire, the operational area encompassing a first charging station and a second charging station, each of the first and second charging stations comprising a base station wire, the robotic work tool comprising a controller, wherein the controller is configured to:
operate in the operational area according to a first control signal, the first control signal comprising a first boundary signal being transmitted through the boundary wire and a first base station signal being transmitted through the base station wire of the first charging station;
navigate the robotic work tool to locate and move the robotic work tool to the first charging station based on the first control signal;
navigate the robotic work tool to distance the robotic work tool from the first charging station in a predetermined manner;
synchronize to a second control signal comprising a first boundary signal and a second base station signal both being transmitted through the base station wire of the second charging station; and
navigate the robotic work tool to enter the second charging station based on the second control signal.

2. The robotic work tool according to claim 1, wherein the robotic work tool is associated with the second charging station, and wherein the controller is further configured to determine that the robotic work tool is associated with the second charging station based on settings.

3. The robotic work tool according to claim 1, wherein the robotic work tool further comprises a sensor for deduced reckoning, and wherein the controller is further configured to navigate the robotic work tool to distance the robotic work tool from the first charging station in the predetermined manner based on deduced reckoning.

4. The robotic work tool according to claim 1, wherein the controller is further configured to navigate the robotic work tool to distance the robotic work tool from the first charging station in the predetermined manner based on the first control signal.

5. The robotic work tool according to claim 1, wherein the controller is further configured to
determine that the robotic work tool is unable to synchronize to the second control signal, and in response thereto
navigate the robotic work tool to reposition the robotic work tool and reattempt to synchronize to the second control signal.

6. The robotic work tool according to claim 5, wherein the controller is further configured to reposition the robotic work tool by navigating the robotic work tool to the first charging station based on the first control signal.

7. The robotic work tool according to claim 5, wherein the controller is further configured to reposition the robotic work tool by navigating the robotic work tool to move a distance.

8. The robotic work tool according to claim 5, wherein the controller is further configured to reposition the robotic work tool by navigating the robotic work tool in a random pattern searching for the second control signal.

9. The robotic work tool according to claim 1, wherein the controller is further configured to navigate the robotic work tool to distance the robotic work tool from the first charging station in the predetermined manner by moving the robotic work tool a predetermined distance from the first charging station.

10. The robotic work tool according to claim 9, wherein the predetermined distance is based on a range of the base station filed.

11. The robotic work tool according to claim 9, wherein the predetermined distance is 2, 3, or 5 meters.

12. The robotic work tool according to claim 9, wherein the controller is further configured to navigate the robotic work tool to distance the robotic work tool from the first charging station in the predetermined manner by turning and then moving the robotic work tool a predetermined distance in a straight line from the first charging station.

13. The robotic work tool according to claim 1, wherein the controller is further configured to navigate the robotic work tool to distance the robotic work tool from the first charging station in the predetermined manner by moving the robotic work tool in a random or semi-random manner.

14. The robotic work tool according to claim 1, wherein the robotic work tool is a robotic lawnmower.

15. A robotic work tool system comprising a first robotic work tool associated with a first charging station and a second robotic work tool associated with a second charging station, wherein the second robotic work tool is an instance of the robotic work tool according to claim 1.

16. A method for use in a robotic work tool arranged to operate in an operational area ounded by a boundary wire, the operational area encompassing a first charging station and a second charging station, each of the first and second charging stations comprising a base station wire, the method comprising:
operating in the operational area according to a first control signal, the first control signal comprising a first boundary signal being transmitted through the boundary wire and a first base station signal being transmitted through the base station wire of the first charging station;
navigating the robotic work tool to locate and move the robotic work tool to the first charging station based on the first control signal;
navigating the robotic work tool to distance the robotic work tool from the first charging station in a predetermined manner;
synchronizing to a second control signal comprising a first boundary signal and a second base station signal both being transmitted through the base station wire of the second charging station; and
navigating the robotic work tool to enter the second charging station based on the second control signal.

17. A charging station arranged to be used with a robotic work tool, wherein the charging station comprises a signal generator arranged to generate a boundary control signal and a base station signal and wherein the charging station is arranged to transmit both the boundary control signal and the base station signal through a base station wire.

18. The charging station according to claim 16, wherein the charging station comprises the base station wire and a base plate, wherein the base station wire is arranged in the base plate.

19. The charging station according to claim 16, wherein the charging station is arranged to be connected to a boundary wire, and is arranged to not transmit the boundary control signal through the boundary wire, when transmitting the boundary control signal through the base station wire.

20. The charging station according to claim 16, wherein the charging station is arranged to be used together with a robotic work tool.
